(19) United States
(12) Patent Application Publication
(10) Pub. No.: US 2014/0289158 A1
(43) Pub. Date: Sep. 25, 2014

(54) METHOD AND APPARATUS FOR RATING A MULTI-VERSION PRODUCT

(71) Applicant: ADOBE SYSTEMS INC., San Jose, CA (US)

(72) Inventors: Aditya Falodiya, Cupertino, CA (US); Saransh Katariya, Indore (IN)

(73) Assignee: Adobe Systems Inc., San Jose, CA (US)

(21) Appl. No.: 13/847,828

(22) Filed: Mar. 20, 2013

(51) Int. Cl. G06Q 30/02

(52) U.S. Cl. CPC G06Q 30/0282
USPC 705/347

(57) ABSTRACT

A method and apparatus for rating a product is disclosed. The method comprises accessing ratings data associated for a plurality of versions of a product; causing display of an indicator, on a timeline, for each version in the plurality of versions; causing display of ratings, on the timeline, for a version of the product; receiving a request to view ratings for a version of the product different from the indicated version; and updating the timeline with ratings for the different version of the product.

### BACKGROUND OF THE INVENTION

1. Field of the Invention

Embodiments of the present invention generally relate to rating techniques and, more particularly, to a method and apparatus for a rating a multi-version product.

2. Description of the Related Art

Ratings for products are provided, for example, by users based on their experience of use, and such ratings provide a potential user an understanding about other users' experience with the product and may assist potential users with making a decision, for example when purchasing the product.

Software products are generally distributed in versions, that is, a product is released in an initial version, and then the product is modified or upgraded over time, and newer versions of the product are released. Conventional rating techniques in use for software products provide a single rating for a product. However, when several versions of a product have been released, a single rating may lead to misleading conclusions about a product.

Therefore, there is a need for a method and apparatus for rating a multi-version product.

### SUMMARY OF THE INVENTION

A method and apparatus for rating a multi-version product substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 depicts a block diagram of an apparatus (generally forming a system) for rating a multi-version product, according to one or more embodiments of the invention;

FIG. 2 depicts a ratings timeline display as populated by the rating retrieval module of FIG. 1, according to one or more embodiments of the invention;

FIG. 3 depicts a flow diagram of a method for causing a ratings display for a version of a multi-version product, as performed by the ratings retrieval module of FIG. 1, according to one or more embodiments of the invention; and

FIG. 4 depicts a flow diagram of a method for receiving a version rating as performed by the ratings registration module of FIG. 1, according to one or more embodiments of the invention.

While the method and apparatus is described herein by way of example for several embodiments and illustrative drawings, those skilled in the art will recognize that the method and apparatus for rating a multi-version product are not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for a multi-version product rating system as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. The term “document” may be used to describe documents, web pages, or any viewable source having a node-hierarchical structure.

### DETAILED DESCRIPTION OF EMBODIMENTS

Embodiments of the present invention provide a method and apparatus for rating a multi-version product. The embodiments provide a mechanism for a user to rate a current version of a product or a previous version of the product on the same ratings timeline. In some embodiments, a future version of a product may be rated, where the rating may be based on news releases or articles, and the like. The method provides a ratings timeline that displays the existing ratings for the multi-version product. The ratings timeline displays ratings for one or more versions of a multi-version product. In some embodiments, a consolidated rating is calculated using data from some or all versions of the product, wherein the consolidated rating represents a weighted average of the ratings from two or more versions of the product. Initially, ratings for the most recent version may be displayed on the ratings timeline, with indicators of other versions of the product. A user may then select a different version of the multi-version product for which the user would like to view ratings. The user may also submit a rating for the selected version of the multi-version product. When a rating is received for a selected version, the method incorporates the rating into the overall rating for the selected version, as well as into a consolidated rating for the product and then updates the ratings timeline with the received rating.

The rating timeline may be displayed on a web page, in a document, and/or the like. When the information that is displayed on the timeline changes or is updated, the remainder of content on the web page, document, etc. remains the same.

Advantageously, embodiments of the present invention disclose a timeline-based rating system. The proposed rating system provides a richer rating experience with respect to the evolution over time of a product across its various versions. With a growing number of frequently updated software products, for example, mobile applications, desktop applications and the like, the proposed embodiments present rating techniques that discern between various versions of products while providing or receiving ratings, and provide a relevant and reliable rating environment. Examples of multi-version products include, but are not limited to, software items, such as applications, plug-ins, etc, as well as non-software items, such as cars, computers and mobile phones, etc. In some embodiments, the product is a frequently upgraded/updated product.

Various embodiments of a rating system for a multi-version product are described. In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

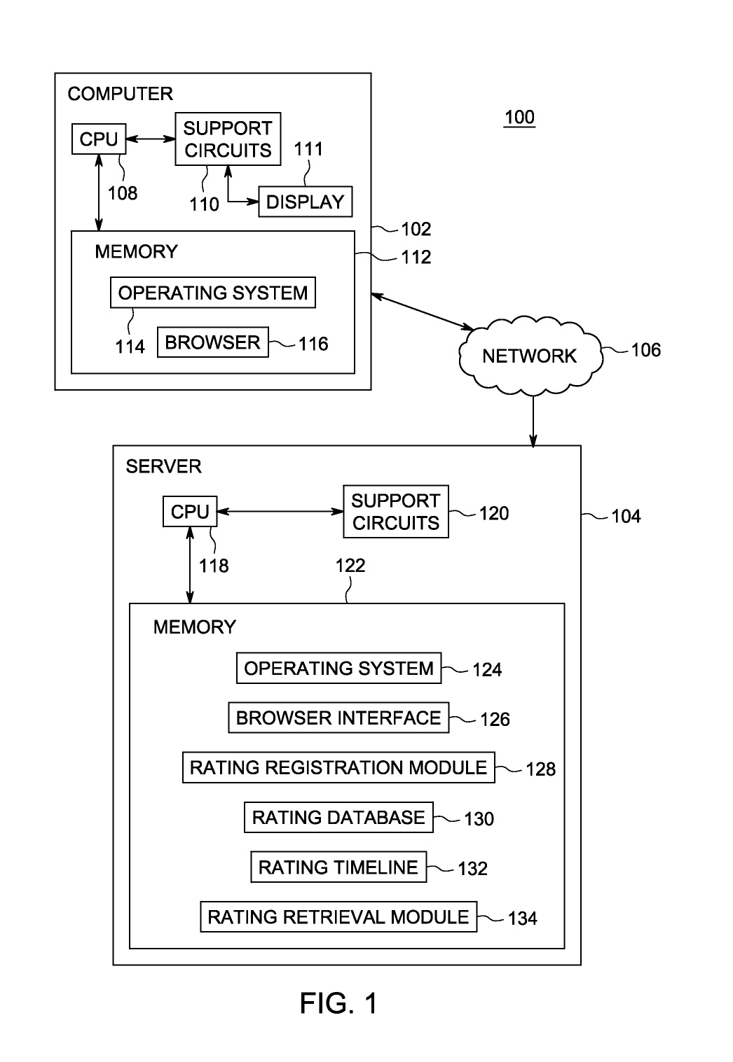

FIG. 1 depicts a block diagram of an apparatus 100 (generally forming a system) for rating a multi-version product, according to one or more embodiments of the invention. Embodiments of the apparatus 100 includes a computer 102, communicatively coupled to a server 104 via a network 106.

The network 106 includes a communication system that connects computers (or devices) by wire, cable, fiber optic and/or wireless link facilitated by various types of well-known network elements, such as hubs, switches, routers, and the like. The network 106 may employ various well-known protocols to communicate information amongst the network resources. For example, the network 106 may be a part of the Internet or Intranet using various communications infrastructures, such as Ethernet, Wi-Fi, Wi-Max, General Packet Radio Service (GPRS), and the like.

The computer 102 is a type of computing device (e.g., a desktop computer, laptop, tablet computer, smart phone, personal digital assistant (PDA), mobile phone, and the like). The computer 102 includes a CPU 108, support circuits 110, a display 111, and a memory 112. The CPU 108 may include one or more commercially available microprocessors or microcontrollers that facilitate data processing and storage. The various support circuits 110 facilitate the operation of the CPU 108 and include one or more clock circuits, power supplies, cache, input/output circuits, displays, and the like. The memory 112 includes at least one of Read Only Memory (ROM), Random Access Memory (RAM), disk drive storage, optical storage, removable storage and/or the like. The memory 112 includes an operating system 114, and a browser 116.

The server 104 is a type of computing device, (e.g., a desktop computer, laptop, tablet computer, smart phone, personal digital assistant (PDA), cellular phone, and the like), or server 104 may be a cloud based server. The server 104 includes a CPU 118, support circuits 120, and a memory 122. The CPU 118 may include one or more commercially available microprocessors or microcontrollers that facilitate data processing and storage. The various support circuits 120 facilitate the operation of the CPU 118 and include one or more clock circuits, power supplies, cache, input/output circuits, displays, and the like. The memory 122 includes at least one of Read Only Memory (ROM), Random Access Memory (RAM), disk drive storage, optical storage, removable storage and/or the like. The memory 122 includes an operating system 124, a browser interface 126, a rating registration module 128, a rating database 130, a ratings timeline 132, and a rating retrieval module 134. The browser interface 126 operates as an interface between the browser 116 and the server 104. The browser interface 126 may be a Graphical User Interface (Gbrowser), a Command Line Interface (CLI) and/or other user interface that facilitates communication between the browser 116 and the server 106.

The computer 102, by executing the browser 116 using the CPU 108, interacts with the server 104. According to some embodiments, the browser 116 includes a software application for accessing Internet resources (e.g., domain names, Uniform Resource Locators (URLs), and/or the like) and displays content associated with the Internet resources on the display 111 of computer 102. The browser 116 may include, but is not limited to, WINDOWS INTERNET EXPLORER®, MOZILLA FIREFOX®, APPLE® SAFARI®, GOOGLE CHROME™, INTERNET EXPLORER® Mobile, WebOS, and/or the like.

In one or more embodiments, the rating retrieval module 134 retrieves data from the rating database 130. The rating database 130 includes data regarding ratings for a product, and more specifically, data regarding individual versions of a product including, but not limited to, a version number, a number of ratings, a time span in which the version was available before a newer version of the product was available, a numeric value of the rating, and the like. The rating retrieval module 134 consolidates the data in a ratings timeline, which is then displayed using the browser 116 and display 111. A user may select a product version on the ratings timeline 132 via the browser 116 and the rating retrieval module 134 updates the data in the ratings timeline 132 to reflect the information for the selected product version. A user may then input a rating for the product version based on the ratings scale displayed in the ratings timeline 132. The rating registration module 128 stores the rating in the rating database 130, recalculates the rating for the version and a consolidated ratings value for the product, and then displays the calculated values on the ratings timeline.

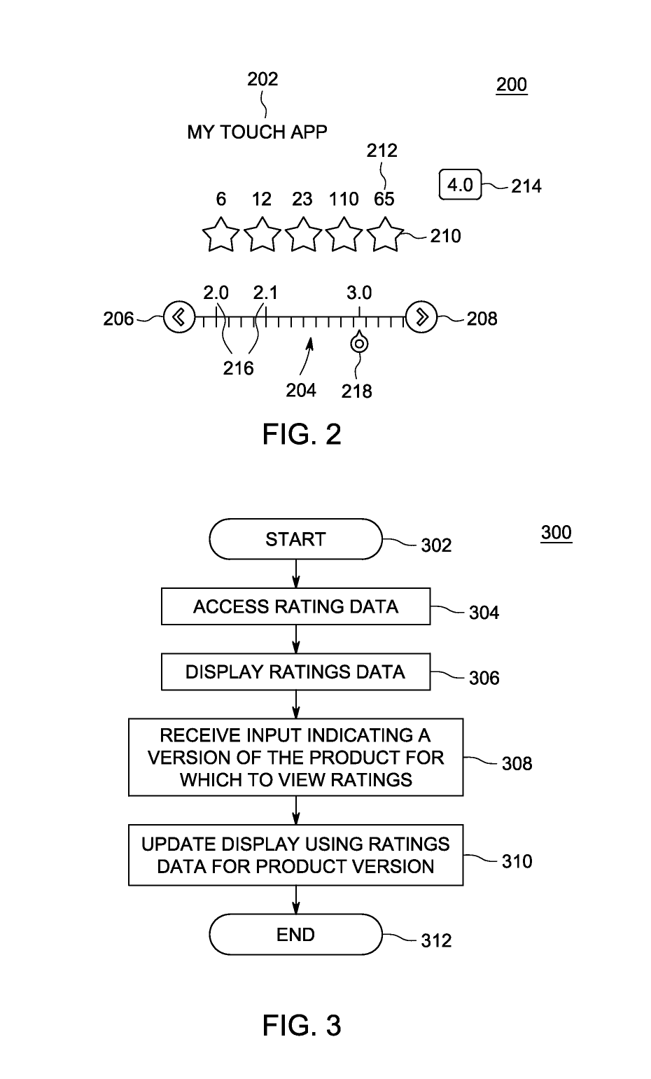

FIG. 2 depicts a ratings timeline display 200 as populated by the rating retrieval module 128 of FIG. 1, according to one or more embodiments. The ratings timeline display 200 includes a product name 202, a timeline 204, a left shift arrow 206, a right shift arrow 208, a graphical ratings display 210 (i.e., a row of five stars), a number of users who selected each rating 212, a consolidated rating 214, version numbers 216, and a pointer 218.

The timeline 204 may represent the lifetime of a product from its initial launch to the current version using predetermined time interval increments, for example months. In some embodiments, the timeline 204 may represent a future version of the product. The product name 202, for example, “My Touch App”, is displayed on the ratings timeline display 200. A predefined number of months are displayed, for example, 18 months, wherein each month may be represent by a tick mark on the timeline 204. If the time from initial launch of a product to the present is longer than 18 months, the left shift arrow 206 and right shift arrow 208 allow a user to alter the timeline view so as to see earlier and later times in the timeline 204. The product version numbers 216 are located on the timeline in chronological order, spaced from left to right starting from when the product was released. In the present example, version 2.1 was released four months after version 2.0. Seven and a half months later, version 3.0 was released.

The pointer 218 is pointing to version 3.0 on the timeline. As such, above the graphical ratings display 210 (i.e., the stars), are the number of users who selected each rating 212 for version 3.0. In this example, at total of 216 users registered ratings for version 3.0. Six users gave My Touch App a one star rating, 12 users gave My Touch App a 2 star rating, 23 users gave My Touch App a 3 star rating, 110 users gave My Touch App a 4 star rating, and 65 users gave My Touch App a 5 star rating. The average rating may be displayed using color coding. In this example, the average rating for version 3.0 is 4, therefore four stars are colored in a manner to differentiate them from the fifth star, thereby indicating a 4 star rating. In the case where the average rating for a version is a decimal, for example, 3.5, three and a half stars are colored in a matter to differentiate them as the average rating. The pointer 218 below the timeline 204 may be moved to point to a different version number 216, for example, version 2.1. The ratings timeline display 200 is then updated with the data for the version 2.1. The consolidated rating 214 is a weighted average as described below with reference to equation 1. The consolidated rating 214 may be calculated for a predefined number of versions of the product. For example, the consolidated rating may be calculated for the three latest versions of the product or for the three most recent versions from the currently displayed version. In some embodiments, the consolidated rating 214 may be calculated for all versions of the product to provide an overall product rating. In some embodiments, multiple consolidated ratings may be shown. In such embodiments, a user may specify for which versions a consolidated rating is desired, for example, a consolidated rating of all versions and a consolidated rating for versions 1, 4, and 5.

The ratings timeline display 200 provides a comprehensive rating for a product across multiple versions, from a product's initial release through the product's current version. Although the ratings timeline display 200 shows linear display of time, other timelines are envisioned that provide the ratings data, such as a circular timeline, and the like.

FIG. 3 depicts a flow diagram of a method 300 for causing a ratings display for a version of a multi-version product, as performed by the rating retrieval module 134 of FIG. 1, according to one or more embodiments of the invention. The method 300 displays a ratings timeline with current ratings for multiple versions of a product and upon receiving a request to view a different version, updates the ratings data in the ratings timeline for the requested different product version.

The method 300 starts at step 302, and proceeds to step 304. At step 304, the method 300 accesses ratings data for a product. Although the exemplary embodiment as described herein relates to a software application, the product may be any product that has multiple versions, such as a software plug-in, a model of a car, multimedia content, such as a movie or book series, and/or the like.

The ratings data is retrieved from a ratings database on a cloud server, wherein the data structure may, for example, be as follows:
{AppID, Version, UserID, Rating, Timestamp}

In the above data structure, the AppID is a data structure that may include an application identifier, an application name, and other information that may be relevant to the application. The version is the version number of the AppID. The UserID is a data structure that may include a user identifier, a user name, and other information specific to a user. The rating may be any rating scale defined for the rating timeline, for example, {1, 2, 3, 4, 5}. The Timestamp is the time and date when the user registers the rating. Actual data in the ratings database may be, for example:
{SampleApp, 1.0, user1@adobe.com, 5, 1/10/2009@12:30pm}
{SampleApp, 1.0, user2@adobe.com, 4, 5/11/2009@2:30pm}
{SampleApp, 2.0, user1@adobe.com, 3, 23/11/2009@1:30pm}

[symbol]

The ratings timeline is typically displayed on website for example, an e-commerce site or app store on the same page as a displayed product. The ratings timeline may also be displayed on a media site, such as IMDB® or any website where a product is displayed. The ratings timeline for product X, with version Y, where the version is indicative of a sequence in time, may be displayed. When the product is displayed, the product identifier (i.e., AppID) that is associated with the product is used by method 300 to retrieve the ratings data from the ratings database. The method 300 sends a query, using the AppID, to retrieve data from the ratings database. In response to the query, the method 300 receives the application name and version information for the product in order to populate version information on the timeline. In some embodiments, the method 300 receives ratings counts for the latest version of the product and a calculated consolidated rating from a pre-defined number of most recent versions, for example, the last three versions. In some embodiments, the method 300 may retrieve ratings counts for the version of the product that is displayed on the e-commerce site or app store and a calculated consolidated rating from a pre-defined number of most recent versions from the product version displayed on the e-commerce site or app store.

The consolidated rating is a rating point weighted average. The consolidated rating is calculated as follows:

$$CR = \frac{{\sum }_{v = 1}^{k} ( {R}_{v} * {T}_{v} )}{{\sum }_{v = 1}^{k} ( {T}_{v} )} \qquad ( Equation 1 )$$

CR is the calculated consolidated rating, V represents the product version, which ranges from 1 to k, Rᵥ represents a product rating for the version v, and Tᵥ represents a product time span for version v. The time span is the amount of time, for example, in months, for which a product version was released before a next product version was released.

Rv, the product rating for the version (in the above equation), is calculate as follows:

$${R}_{v} = \frac{{\sum }_{p = 1}^{n} ( {C}_{p} * {R}_{p} )}{{\sum }_{p = 1}^{n} ( {C}_{p} )} \qquad ( Equation 2 )$$

In the equation to calculate the product rating, p represents the ratings points within the range 1 to n, Cₚ represents the count for rating point p, and Rₚ represents the numeric value of rating point p.

Consider, for example, the ratings data for Product A in Table 1 below.

TABLE 1

| Version | 1.0 | 1.5 | 2.0 | 3.0 | 4.0 |
|---|---|---|---|---|---|
| Time span (months) | 12 | 6 | 12 | 12 | 12 |
| Rating | 2.0 | 3.0 | 4.0 | 4.5 | 4.2 |

There are five versions of Product A, namely 1.0, 1.5, 2.0, 3.0, and 4.0. The time span of a version is the amount of time a version was in release before the next version release or for the latest release, the amount of time since the release of the latest version. The rating is the calculated product rating for the version. A consolidated rating for the lifetime of the product, i.e., CR (54 months), calculated using the above equation, is 3.6. The consolidated rating for the last three versions of the product, i.e., CR (36 months) calculated using the above equation, is 4.23. In the present example, the consolidated rating for the three most recent versions is higher than the consolidated rating over the lifetime of the product which may indicate that the product has improved since its initial release.

The method 300 proceeds to step 306, where the method 300 displays the ratings data of the product on the ratings timeline. The method 300 tallies a count for each of the ratings values (e.g., 1-5), and displays them above each rating. The method 300 then calculates an average for the release using Equation 2 above. The method 300 causes display of the data on the ratings timeline display as described with respect to FIG. 2 above, including the tallied ratings, and an indication on the graphical rating display of the average rating for the product.

The method 300 proceeds to step 308, where the method 300 receives input indicating a selection to view a version different from the version that is currently displayed. In some embodiments, the input may be received by way of a movement in the pointer on the timeline to a point representing a different version. The method 300 proceeds to step 310, where the method 300 sends a query to the rating database using the AppID and a version number. In response, the method 300 receives ratings counts for the selected version and a calculated consolidated rating from a pre-defined number of most recent versions from the product version. The method 300 tallies the ratings, calculates an average rating for the selected version and updates the ratings timeline with the new data. The method 300 proceeds to step 312 and ends.

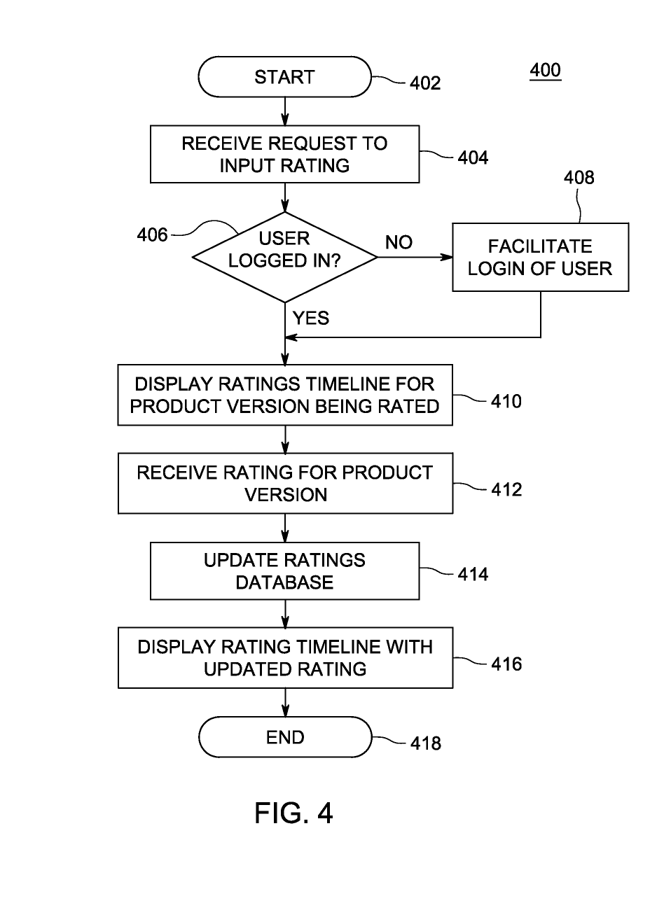

FIG. 4 depicts a flow diagram of a method 400 for receiving a version rating as performed by the rating registration module 128 of FIG. 1, according to one or more embodiments of the invention. The method 400 receives a request to input a rating, requests a user's login information, receives the rating, and updates the ratings timeline to include the new rating. In some embodiments, a user may login and then indicate an intention to rate a version of the product. Upon entry of rating mode, the user may select a version to rate. In some embodiments, a user may view a particular version for which the user would like to provide a rating and then enter rating mode, provide login information and provide the rating. The method 400 starts at step 402 and proceeds to step 404.

At step 404, the method 400 receives a request to enter a rating mode in order to provide a rating for a product. In some embodiments, the rating mode is selected in response to an input. In some embodiments, the input may be provided by a user. In some embodiments, the rating mode is entered by selecting a button, for example, a “rate this product” button in a user interface. The method 400 proceeds to step 406, where the method 400 determines whether the user is logged into the ratings server. If the user is not logged in, the method 400 proceeds to step 408, where the method 400 facilitates a user login and stores the userID from the user login before proceeding to step 410. If at step 406, the method 400 determines that the user is already logged in, then the method 400 already has the userID for the user stored and the method 400 proceeds to step 410.

At step 410, the method 400 displays the ratings timeline for the product as described with respect to FIG. 3 above. The user may then select a version of the product for which the user would like to provide a rating. The ratings timeline display is updated with ratings data from the selected version, as described with respect to FIG. 3 above. The method 400 proceeds to step 412.

At step 412, the method 400 receives a rating of the selected version. The rating may be received as an indicated number of stars, a numeric value, or any indication of a rating on the ratings scale. The method 400 proceeds to step 414, where the method 400 updates the rating database based on the received rating. The rating is stored in the rating database using the data structure described for the rating database above, storing the AppID, version, UserID, rating, and timestamp for the rating.

The method 400 proceeds to step 416, where the method 400 displays the ratings timeline with the current ratings information in the same manner as described in steps 304-306 of method 300 above. The method 400 proceeds to step 418 and ends.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method comprising:
accessing ratings data associated with a plurality of versions of a product;
causing display of an indicator on a timeline, for each version in the plurality of versions;
causing display of ratings, on the timeline, for an indicated version of the product;
receiving a request to view ratings for a version of the product different from the indicated version; and
causing updating of the timeline with ratings for the different version of the product.

2. The method of claim 1, further comprising:
receiving a rating for the different version of the product; and
causing updating of the timeline with ratings reflective of the received rating.

3. The method of claim 1, wherein causing display of ratings comprises tallying a rating count for each rating on a rating scale; calculating an average rating for the version of the product; causing display of the rating count for each rating on the rating scale, and indicating the average rating for the version of the product.

4. The method of claim 1, wherein the request is received when a pointer on the timeline is relocated on the timeline to refer to an indicator for a version that is different from the version currently displayed on the timeline.

5. The method of claim 1, further comprising calculating a consolidated rating for a predefined number of versions of the product, wherein the consolidate rating is a weighted rating for the predefined number of versions of the product.

6. The method of claim 5, wherein the consolidated rating is calculated using the equation:
$$CR = \frac{{\sum }_{v = 1}^{k} ( {R}_{v} * {T}_{v} )}{{\sum }_{v = 1}^{k} ( {T}_{v} )} ,$$
wherein CR is the calculated consolidated rating, V represents a product version, which ranges from 1 to k, Rᵥ represents a product rating for the version v, and Tᵥ represents a product time span for version v, wherein a product time span is an amount of time which a version was available before a newer version of the product was available.

7. The method of claim 1, wherein updating comprises accessing ratings data for the different version, tallying a rating count for each rating on a rating scale for the different version; calculating an average rating for the different version of the product; causing display of the rating count for each rating on the rating scale for the different version, and indicating the average rating for the different version of the product.

8. An apparatus for a product rating system comprising:
a rating database for storing rating data associated with the plurality of versions of a product; and
a rating retrieval module for accessing ratings data associated with the plurality of versions of the product, causing display, on a timeline, of an indicator for each version in the plurality of versions, causing display of ratings, on the timeline, for a version of the product, receiving a request to view ratings for a different version of the version; and updating the timeline with ratings for the different version of the product.

9. The apparatus of claim 8, further comprising:
a rating registration module for receiving a rating for the different version of the product and causing updating the timeline with ratings reflective of the received rating.

10. The apparatus of claim 8, wherein causing display of ratings comprises tallying a rating count for each rating on a rating scale; calculating an average rating for the version of the product; causing display of the rating count for each rating on the rating scale, and indicating the average rating for the version of the product.

11. The apparatus of claim 8, wherein the request is received when a pointer on the timeline is relocated on the timeline to refer to an indicator for a version that is different from the version currently displayed on the timeline.

12. The apparatus of claim 8, further comprising calculating a consolidated rating for a predefined number of versions of the product, wherein the consolidate rating is a weighted rating for the predefined number of versions of the product.

13. The apparatus of claim 8, wherein updating comprises accessing ratings data for the different version, tallying a rating count for each rating on a rating scale for the different version; calculating an average rating for the different version of the product; causing display of the rating count for each rating on the rating scale for the different version, and indicating the average rating for the different version of the product.

14. A non-transient computer readable medium for storing computer instructions that, when executed by at least one processor causes the at least one processor to perform a method for processing data for a product rating system, comprising:
causing a change of display of ratings from a first version of a product to a second version of the product;
receiving a rating for the second version of the product; and
causing a change in display of ratings for the second version of the product.

15. The computer readable medium of claim 14, further comprising causing display of ratings of the first version, wherein causing display comprises tallying a rating count for each rating on a rating scale and calculating an average rating for the first version of the product.

16. The computer readable medium of claim 15, further comprising causing display of the rating count for each rating on the rating scale, indicating the average rating for the first version of the product, and calculating a consolidated rating for a predefined number of versions of the product.

17. The computer readable medium of claim 14, wherein causing a change in display of ratings for the second version comprises accessing ratings data for the second version, wherein the ratings data includes the received rating, and tallying a rating count for each rating on a rating scale for the second version.

18. The computer readable medium of claim 17, further comprises calculating an average rating for the second version of the product; causing display of the rating count for each rating on the rating scale for the second version, and indicating the average rating for the second version of the product.

19. The computer readable medium of claim 18, further comprises recalculating a consolidated rating for a predefined number of versions of the product, wherein the consolidate rating is a weighted rating for the predefined number of versions of the product.

20. The computer readable medium of claim 19, wherein the consolidated rating is calculated using the equation:
$$CR = \frac{{\sum }_{v = 1}^{k} ( {R}_{v} * {T}_{v} )}{{\sum }_{v = 1}^{k} ( {T}_{v} )} ,$$
wherein CR is the calculated consolidated rating, V represents a product version, which ranges from 1 to k, Rᵥ represents a product rating for the version v, and Tᵥ represents a product time span for version v, wherein a product time span is an amount of time which a version was available before a newer version of the product was available.
